(19) United States
(12) Patent Application Publication
(10) Pub. No.: US 2026/0307296 A1
(43) Pub. Date: Oct. 8, 2026

(54) SYSTEM AND METHOD FOR PRODUCING A CONSTRUCTION MATERIAL SUSPENSION AT A CONSTRUCTION SITE

(71) Applicant: BAUER MAT Slurry Handling Systems Zweigniederlassung der BAUER Maschinen GmbH, Immenstadt-Seifen (DE)

(72) Inventor: Rolf DÄUMLER, Burgberg (DE)

(73) Assignee: BAUER MAT Slurry Handling Systems Zweigniederlassung der BAUER Maschinen GmbH, Immenstadt-Seifen (DE)

(21) Appl. No.: 19/634,573

(22) Filed: Mar. 31, 2026

(30) Foreign Application Priority Data
Apr. 7, 2025 (EP) 25168732.3

(51) Int. Cl. B28C 7/04; B28C 7/06

(52) U.S. Cl. CPC B28C 7/0436; B28C 7/0418; B28C 7/067

(57) ABSTRACT

System for batchwise producing a construction material suspension at a construction site, with a water supply (1), in particular a water tank, with a first metering device at an outlet, at least one stockpiling silo (2, 3) for in each case a free-flowing or flowable substance, in particular a solid, wherein the or each stockpiling silo (2, 3) is provided with a respective second metering device at an outlet, a mixer (4) which is arranged such that it can be charged with mixing water from the water supply (1) and substance, in particular solid, from the at least one or each stockpiling silo (2, 3) by opening the respective first and second metering devices, wherein a weighing system (5) for continuously measuring the masses of substances fed into the mixer (4) is assigned to the mixer (4), and a control unit which is configured to actuate the first and second metering devices to open and close on the basis of mass target values of a specifiable recipe in order successively to feed mixing water and solid/solids of a batch of the construction material suspension into the mixer (4) according to the recipe, wherein the respective metering device is actuated to close as soon as the mass target value of the respective mixing water/substance according to the recipe has been fed into the mixer (4). The control unit is configured, to, after actuating to close the respective metering device and before actuating to open a next metering device, within a defined time interval, to check/determine a deviation between an actual value of a measured value from the weighing system (5) and the target value of the mass previously fed into the mixer (4) of a substance and to determine, from the deviation, a change of a closing time of the respective metering device, which is used/taken into account during the production of a subsequent batch of the same recipe when actuating the closing of the respective metering device.

The invention relates to a system and a method for batchwise producing a construction material suspension at a construction site.

Typical construction methods in which construction material suspensions are produced on site at a construction site by mixing water with solids and, if applicable, further additions are the production of anchors (strand anchors, self-drilling anchors or micropiles) or soil-mixing methods such as, for example, milling mixing methods, single- or multi-column mixing methods.

As a rule, suspensions on construction sites in special foundation engineering are produced with suitable mixing systems which comprise a mixer, storage silo(s) for the solids, e.g. cement, bentonite, etc., and, if applicable, further additions as well as a water supply.

The mixer is usually charged with mixing water via a water feed line with corresponding dosing elements such as flaps or shut-off valves or tank systems. The solid dosing is usually carried out via a screw conveyor which is mounted on an outlet of a storage silo. The flaps, shut-off valves and screw conveyors are collectively referred to in the context of the present disclosure under the term “metering devices”, which are actuated to start and stop a supply of the respective substance, for example opened, closed or otherwise activated or stopped or switched off.

The term “substances” includes, in the context of the present disclosure, water as well as other liquids and solids/additives, i.e. all free-flowing and flowable substances, also substance mixtures, which are typically automatically metered, combined and mixed by a system in quantities “customary on construction sites” as components of a recipe for producing a construction material suspension.

A dosing controller controls, in conjunction with the mixer with weighing system, if applicable a delivery rate measurement in the case of liquids, the batchwise production of the suspension on the basis of recipe specifications that were entered into the system controller before the start of suspension production or retrieved from a memory. The added component quantities can be weighed in the mixer by the weighing system. For metering the components, the dosing controller of the system controller (to start and stop) outputs signals to the metering devices, wherein the metering of the components into the mixer takes place one after the other in time.

The increasing weight of the respectively metered component is detected by the weighing system of the mixer, and when the final weight is reached, the dosing controller of the system controller outputs a signal for closing or switching off the respective metering device.

Due to time delays in signal transmission, component-related switching hysteresis, start-up delays of a screw conveyor, pipe lengths downstream of a metering device, dead volumes, clumping of substances, etc., there is a delayed closing or switching off of the metering device and/or an uncontrolled afterflow of substances into the mixer or a retention of quantities of substances upstream of the mixer in dead volumes or clumps and, as a result, an over- or underdosing of individual substances in the batch currently produced in the mixer. Deviations from the recipe in individual batches and thus also deviations in suspension quality and its properties are the consequence.

In the dosing of powdered solids from silos by means of a screw conveyor, a dosing error can occur in this context in particular, since screw conveyors, depending on their fill level, have a defined conveying capacity as a function of pitch, diameter and rotational speed of the screw flight. Depending on how well or poorly the solid flows afterward from the silo into the screw inlet, the fill level of the screw and thus the conveying capacity changes. This matter is also strongly influenced by the varying fill level of the silo and moisture or temperature changes due to the weather.

In practice, this over- or underdosing is, where possible, compensated by a manual change of the dosing quantities, deviating from the specified recipe. A quality verification with reference to the actual composition of the produced suspension batch is thus, insofar as it can be carried out at all, questionable.

In the batchwise production of construction material suspensions at a construction site, a number of problems thus potentially arise, such as the over- or underdosing of mixing components during suspension production deviating from a desired recipe with the resulting deviation from the desired or planned quality and properties, inadequate documentation of the components actually contained in a particular batch of the produced suspension and/or their quantities as well as the circumstances of the production process (date, time of day, temperatures, location, humidity, etc.), overly late scheduling of used solids and the from it resulting production failures and delays due to a lack of precise knowledge of the actually consumed quantities, which also affect subsequent processing steps, as well as additional consumption of solids and/or additions due to inaccurate metering of the target quantities and thus additional costs.

From this multitude of disturbance variables, constantly changing influences on the accuracy of dosing of components into a mixer and/or into a batch of a suspension produced therewith result, deviating from the recipe specification.

In order nevertheless to achieve constancy in suspension density and composition, an operator of the mixing system is forced to constantly perform manual adjustments to the recipe input or system parameters. The individual experience or lack of experience of the operators has a major influence on the quality of the suspension. A high reproducibility of the batch composition even with the same recipe specification is therefore hardly possible.

It is therefore the object of the present invention to solve at least some of these problems and, in particular, to improve the quality of construction material suspensions produced in batches and the efficiency of the process.

As solution, the invention proposes a system for batchwise producing a construction material suspension at a construction site according to claim 1 and a method for batchwise producing a construction material suspension with the features of claim 9. Preferred embodiments are specified in the respective dependent claims.

In particular, the invention thus relates to a system for batchwise producing a construction material suspension at a construction site, with a water supply, in particular a water tank, with a first metering device at an outlet, at least one stockpiling silo for in each case a free-flowing or flowable substance, in particular a solid, wherein the or each stockpiling silo is provided with a respective second metering device at an outlet, a mixer which is arranged such that it can be charged with mixing water from the water supply and the substance, in particular the solid, from the at least one or each stockpiling silo (and, if required, with one or more liquid additives) by opening the respective first and second metering devices, wherein a weighing system for continuously measuring the masses of substances fed into the mixer is assigned to the mixer, and a control unit which is configured to actuate the first and second metering devices for opening and closing on the basis of mass target values of a specifiable recipe in order successively to feed the mixing water and the substance/substances (and, if applicable, liquid additives) of a batch of the construction material suspension into the mixer according to the recipe, wherein the respective metering device is actuated to close as soon as the mass target value of the respective mixing water/substance (or the target quantity of the additive) according to the recipe has been fed into the mixer.

According to the invention, the control unit is furthermore configured, to after actuating to close the respective metering device and before actuating to open a next metering device, within a defined time interval, to check/determine a deviation of an actual value of a measured value from the weighing system from the target value of the mass previously fed into the mixer of a substance and to determine, from the deviation, a change of a closing time of the respective metering device, which is (automatically) used/taken into account during the production of a subsequent batch of the same recipe when actuating the closing of the respective metering device.

In particular, the invention thus also relates to a method for batchwise producing a construction material suspension at a construction site, with a system which comprises a water supply, in particular a water tank, with a first metering device at an outlet, at least one stockpiling silo for in each case a free-flowing or flowable substance, in particular a solid, wherein the or each stockpiling silo is provided with a respective second metering device at an outlet, and a mixer which is arranged such that it can be charged with mixing water from the water supply and the substance, in particular the solid, from the at least one or each stockpiling silo by opening the respective first and second metering devices, wherein a weighing system for continuously measuring the masses of substances fed into the mixer is assigned to the mixer, comprising the steps:
Specifying a recipe with mass target values of substances of a batch of the construction material suspension to be produced, and
Actuating, on the basis of the mass target values of the recipe, the first and second metering devices for opening and closing in order successively to feed mixing water and the substance/substances of a batch of the construction material suspension into the mixer according to the recipe, wherein the respective metering device is actuated to close as soon as the mass target value of the respective mixing water/substance according to the recipe has been fed into the mixer.

According to the invention, after actuating to close the respective metering device and before actuating to open a next metering device, within a defined time interval, a deviation of an actual value of a measured value from the weighing system from the target value of the mass previously fed into the mixer of a substance is checked/determined and, from the deviation, a change of a closing time of the respective metering device is determined, which is (automatically) used/taken into account during the production of a subsequent batch of the same recipe when actuating the closing of the respective metering device.

The control unit thus adjusts, throughout the entire production process from batch to batch, the time corrections of the signals for switching off the respective metering devices.

The system and the method of the invention are based on the basic concept of automatically improving the compliance of compositions of construction material suspensions produced in batches according to a recipe specification in that deviations of a target value of the mass of individual components of the recipe from an actual value of the mass in the course of producing a (first) batch are automatically determined and stored and, on the basis of the determined deviation of the masses, the times at which the associated metering devices are actuated to stop the supply are likewise automatically corrected during the production of a subsequent (second) batch of the same recipe, i.e. are rescheduled forward or rescheduled afterwards.

Because multiple batches are usually produced repeatedly at a given construction site one after another and/or in close temporal connection, numerous relevant and complex influences on the accuracy of an effective metering of the component masses to a batch on site can be determined in a simple manner, namely solely by detecting the actual value of the fed mass by the weighing system of the mixer being present anyway, and can be compensated in a subsequent batch by influencing a single parameter, namely shifting the time of the signal output to the respective metering device for stopping the supply.

The duration of the defined time interval, in which, after issuing the signal for closing a respective metering device, a deviation of an actual value of a measured value from the weighing system from the target value of the mass previously fed into the mixer of a substance is checked/determined, can be specified fixedly or variably or can be determined dynamically, for example by focusing on a rate of change (change of the detected mass per time) and aborting the checking phase when the rate of change falls below a threshold value.

In this way, the quality of the suspension composition of each individual batch can be ensured, anyway upon repetition, quasi automatically and without control interventions by an operator, and the reproduction accuracy can be increased even with temporarily acting and complex influences, i.e. influences that can be detected directly only with great system-technical effort. A change of a parameter that influences the quantity of substances (water and/or liquid or solid/additive) actually introduced into the mixer is therefore already corrected in the respectively subsequent batch and does not affect a large number of batches, even if the change existed only temporarily.

The system and/or the corresponding method is capable of carrying out repeated mixing processes on site at a construction site fully automatically without permanent interventions by personnel. The invention enables the reduction of costs with simultaneously improved efficiency, quality and reproducibility as well as documentation of the production result. A system operator, if present, can thus concentrate on monitoring the overall process and quality assurance.

By automatically preventing overdosing, unnecessary consumption of raw materials, in particular of construction materials in the form of cement, bentonite, etc., is avoided or reduced by the system and/or the method and a reject rate is reduced.

Preferably, the control unit is configured to actuate the first and second metering devices to close as a function of a measured value from the weighing system, wherein the respective metering device is actuated to close as soon as the mass target value of the respective mixing water/substance according to the recipe has been fed into the mixer as a function of the measured value from the weighing system. This variant of gravimetric dosing of the substances into the mixer is particularly preferred due to its greater accuracy, wherein, in the more general approach of the invention, however, dosing as a function of a time-based actuation of the metering devices and/or a volumetric actuation of the metering devices is also intended to be included if corresponding relationships to the specifications of the recipe are present (retrievable by the control unit from a memory or determinable on the basis of a stored functional relationship). The subsequent checking of the deviation between actual value and target value by means of the weighing system remains unaffected thereby.

Preferably, the control unit is furthermore configured, in the event of an overshoot of the actual value above the target value, to schedule forward the closing time of the respective metering device and/or the output of the corresponding command signal (compared to the time in the preceding batch), and, in the event of an undershoot of the actual value relative to the target value, to schedule afterward the closing time of the respective metering device and/or to delay the output of the corresponding command signal. For this purpose, it may be necessary, if necessary, on the basis of the mass deviation between actual value and target value determined during production of the preceding batch, to determine a time interval in which the quantity of substance corresponding to the difference is fed while the metering device is open. This can, for example, be determined currently on the basis of the data acquired during operation and/or stored in the control unit. The shifting of the closing time corresponding to the detected deviation anyway results in the metering device concerned being closed, for example, slightly earlier during production of the next batch, and the afterflow of substance after issuing the closing signal then leads just to the actual value of the mass fed into the mixer corresponding to the target value of the recipe.

Preferably, the control unit is furthermore configured such that a dosing tolerance for the respective substance can also be specified with the recipe and the dosing tolerance is taken into account in the checking of the deviation and/or the comparison of actual value and target value after closing the respective metering device and determining the change of the closing time of the respective metering device. By specification of a certain tolerance for each substance of a recipe, for example +/−2%, the value of which can also be changed, the actual value of the fed mass of the substance may deviate from the target value of the mass according to the recipe according to the specified dosing tolerance without a time shift of the closing time being triggered in the subsequent batch.

Preferably, the control unit is furthermore configured to log the actual values of the mass of substances fed into the mixer during the production of a respective batch which are detected after closing the respective metering device in the context of the checking, and to provide them as an identifiable data set, preferably together with a date/time stamp and/or detected environmental or operating data. If the monitoring process takes place in all dosing processes and after each batch and the detection result is logged, a complete documentation of the actual batch compositions, if applicable in conjunction with other relevant parameters, is ensured. This improves the quality of the process and facilitates a research of causes in the event of possible damage events.

In this log, for each batch, for example, date, time, a duration of each individual dosing process, actual dosing quantities of each individual component, the target/actual comparison of the dosing quantities of each individual component, mixing and emptying time of the mixer, the total batch production time, the maximum current consumption of the mixer drive as well as, if applicable, further environmental parameters such as location (coordinates-if available), temperature, air humidity, etc. are stored hence. A log for each batch with the actual values of the quantities of substances contained and/or fed into the mixer and, if applicable, further data that can be selected from those mentioned above, can, for example, be output in a tabular csv format.

Preferably, the control unit is furthermore configured to log the actual values, detected after closing the respective metering device in the course of the checking, of the substances fed into the mixer during production of multiple batches and to cumulate them as a consumption value of the respective substances and to provide them as an identifiable data set, and preferably to trigger a warning and/or an order for replenishment of the respective substance when it is determined that a certain stock of the respective substance in the stockpiling silo falls below a threshold.

The actual dosing quantities of each individual component determined from the batch log can, for example, be automatically stored and cumulated in different memories of the control unit. This storage of the actual consumption quantities of the individual substances serves the overview of the component consumptions and enables an early scheduling of required materials (e.g. replenishment of cement or bentonite).

Furthermore, the suspension density can be determined from the logs for quality assurance.

The control unit can furthermore be configured to determine and provide, on the basis of the logged data sets, a current, possible mixing output and/or capacity of the system in order to support production planning and control of downstream processes and/or devices.

For operation of the system, in particular of the control unit, the control unit can have a display with a touch screen for touch inputs, on which components of the system and their production-relevant parameters for monitoring the sequences of events in a process diagram are visualized and inputs, in particular of the recipes, can be made.

Operation of the control unit can thus advantageously be visualized and carried out via a display on a touch screen for touch inputs. The graphical representation of the individual components of the system in a process diagram enables an intuitive understanding of all system components, their interaction in operation and their current operating status, as well as an interactive, dynamic user interface and menu navigation for entering production-relevant parameters or recipes and for monitoring the sequences of events in real time.

As a result, the effort for training and instruction of personnel can be reduced and even less qualified personnel can quickly find their way around the control system.

By distributing and/or making the generated data accessible in a network, multiple combined systems and machines linked therewith can also be controlled.

For example, an expanded system can have multiple mixers for independent production of batches of a construction material suspension (with the same or also different recipe) which are supplied by the same water supply and the same storage silos. The merge of the actual consumption data on the basis of the batch logs facilitates the cross-system monitoring of stocks and consumptions and organization of replenishment.

The signal transport (control commands for metering devices from the control unit to the metering devices) and the data exchange of the logs can be realized on the basis of a wired data transmission or by a wireless, i.e. radio-based, data transmission.

Providing the data and/or the logs of a system for a remote access enables a remote operation, a remote support and rapid assistance in the event of faults and facilitates troubleshooting.

The effects described above apply equally to the system and to the method.

The invention is explained below on the basis of an exemplary embodiment with reference to the accompanying drawing. In this show:

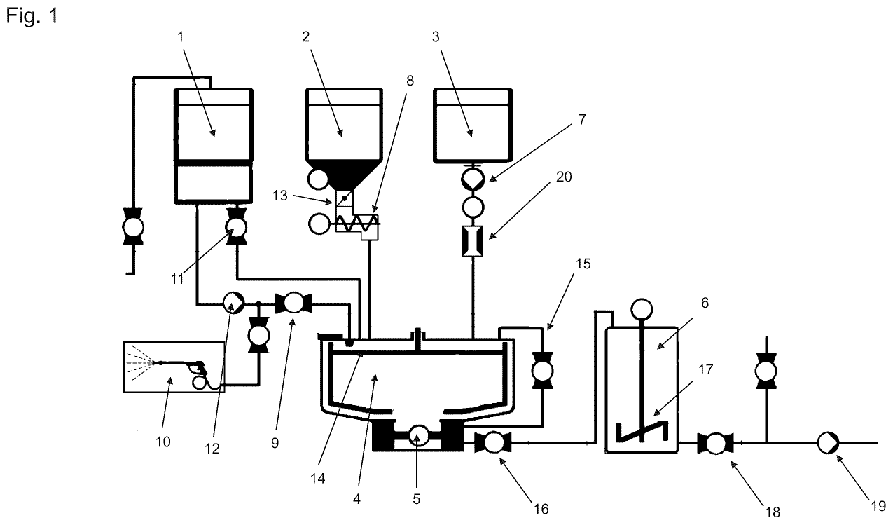

FIG. 1 a system diagram of an exemplary mixing system for batchwise producing a construction material suspension at a construction site.

The system, shown schematically in FIG. 1, serves to explain features of the invention, wherein not all components shown are absolutely necessary for implementing the invention. A superordinate control unit that is connected to and communicates with the individual components of the system is not shown in the diagram.

The system for batchwise producing a construction material suspension comprises, as a necessary component, a water supply 1, for example with a water tank as a buffer, with a first metering device at an outlet. The water tank can be configured with an automatic fill control including fill level monitoring in order to keep the fill level and thus the water pressure at the outlet at a constant level. The metering device can comprise a remotely actuated, controllable valve 11 or a controllable pump 12, if applicable in conjunction with a remotely actuated, controllable valve 9.

The water supply 1 can be connected to a spray lance 10, which does not constitute a necessary component of the system for mixing, but can be used for cleaning purposes in the surroundings thereof.

The system comprises, as a further necessary component, at least one stockpiling silo 2 for in each case a free-flowing solid, wherein the or each stockpiling silo is provided with a respective second metering device at an outlet. The second metering device can, in this case, comprise a screw conveyor 8 into which the solid is introduced from an outlet of the stockpiling silo 2, if applicable via a remotely actuated control flap 13, and whose operation is controlled via the control unit. If multiple solids are required for producing a recipe, multiple of these stockpiling silos 2 can be provided.

The system then comprises, as a further necessary component, a mixer 4 which is arranged such that it can be charged with mixing water from the water supply 1 and flowable or free-flowing substance or substance mixture, in particular solid or also liquid and/or additive, from the at least one or each stockpiling silo 2 by opening the respective first and second metering devices.

A weighing system 5 for continuously measuring and/or weighing the masses of substances fed into the mixer 4 is assigned to the mixer 4, and the weighing system 5 is likewise connected to the control unit in order continuously to provide this with the detection and/or measurement result as an input signal. The mixer is provided with a rotatable stirring and/or mixing device 14 in a mixing chamber, the operation of which is likewise controlled by the control unit. The mixer can be designed as a colloidal suspension mixer with integrated weighing system, and can have a circulation device 15 that can be controlled by the control unit and devices for monitoring safety devices.

For adding further additions and/or additives, if applicable in liquid form or solid form and/or powder form, into the mixer, one or more further stockpiling silo(s) or tanks 3 can be provided, each of which has a (second) metering device which—in dependence on the consistency of the respective substance—does not necessarily have to comprise a screw conveyor, but can also comprise a feed pump 7, if applicable with flow-through meter 20, which, however, can likewise be controlled by the control unit in order to transfer specific quantities of the respective substance (addition and/or additive) into the mixer 4 according to specifications of the recipe. The quantities of these additions and/or additives determined or determinable with sufficient accuracy by the flow-through meter 20 must, if applicable, not necessarily be detected, controlled and determined (again) with regard to a deviation from the target value via the weighing system. Rather, the added quantities can also be determined on the basis of the measurement of the flow-through meter 20 and automatically included in the log of the batch composition.

An emptying device, here with a valve 16, controllable via the control unit is connected to the mixer 4 in order to discharge a finished batch of the suspension from the mixer 4 and to transfer it into an optional storage container 6, here with integrated agitator 17. This storage container 6 can be provided with a fill level monitoring unit (not shown) and monitoring of safety devices which, together with the agitator 17, can communicate with the control unit.

From the storage container 6 (or, if it is absent, directly from the mixer 4), the suspension can be discharged as required and according to work progress, if applicable by using a controllable valve 18 and a feed pump 19, and transported to a point of consumption at the construction site.

The sequence of events of the processes being controlled by the control unit for batchwise producing a construction material suspension is simplified with it as follows:

The control unit starts the dosing process of the respective components and/or substances according to a recipe for producing a batch of the suspension generally successively (so that the measurement of the fed quantity at weighing system of the mixer also relates only to a respective substance) by outputting a control signal for opening the respective metering device and monitors the quantity dosed into the mixer 4 via the signal of the weighing system.

When the target value according to the recipe for the respective substance is reached, the control unit stops the dosing process by outputting a control signal to the corresponding metering device and continues, within a defined time interval, to detect the measured actual quantity (and/or the associated measured value from the weighing system) and compares it with the target value.

If the control unit detects at the end of the defined time interval an overdosing, it automatically determines the time of output of the control signal for stopping the dosing process by which it must be scheduled forward in order to compensate the difference between actual and target value, and stores this as a correction value for the use in producing the next batch in a memory. Only then does the control unit start the dosing process of the next component and/or the next substance according to the recipe (and proceeds in a corresponding manner when stopping). In the opposite sense, the control works in the case of underdosing, wherein then the signal output for switching off the metering device in the next batch takes place with a delay.

The control unit can take into account the correction values for actuating the respective metering device to close that are stored or entered in the memory on the basis of earlier dosing processes and/or batch production but also already during production of a first batch and/or during production of batches with an other recipe, at least as an initial setting, if it turns out that this metering device, for example a screw conveyor, should always be stopped scheduled forward by the determined correction value for a specific substance and/or a specific substance composition and properties in order to discharge into the mixer a quantity of the substance provided in the recipe. It is also conceivable to store the correction values over a longer period of time and to assign them to different constellations (substances, added quantities, further parameters) in order to be able to select the suitable correction value as a starting or default value. The use of principles of “machine learning” for automatic determination of correlations is also conceivable.

After addition of all substances of a batch, the control unit documents the detected actual values of the individual additions of this batch and, if applicable, further parameters for identifying the batch in a log and stores it.

The finished batch can then be discharged from the mixer and transferred directly to the point of consumption or into the storage container.

1. A system for batchwise producing a construction material suspension, comprising
a water supply tank with a first metering device at an outlet thereof,
at least one stockpiling silo for storing a free-flowing or flowable solid substance, the at least one stockpiling silo having a respective second metering device at an outlet thereof,
a mixer arranged such that it is chargeable with mixing water from the water supply tank and the solid substance from the at least one stockpiling silo by opening the respective first and second metering devices,
a weighing system for continuously measuring a mass of the mixing water and a mass of the solid substance fed into the mixer, and
a control unit configured to actuate the first and second metering devices for opening and closing based on mass target values of a specifiable recipe to sequentially feed the mixing water and the solid substance of a batch of the construction material suspension into the mixer according to the recipe, wherein a respective one of the metering devices is actuated to close when the mass target value of the respective mixing water or solid substance according to the recipe has been fed into the mixer,
wherein
the control unit is further configured to, after actuating to close the respective one of the metering devices and before actuating to open a next metering device, within a defined time interval determine a deviation between an actual measured value from the weighing system and the target value of a mass previously fed into the mixer, and to determine, from the deviation, a change of a closing time of the respective one of the metering devices and use the change of the closing time during production of a subsequent batch of the recipe when actuating the closing of the respective one of the metering devices.

2. The system according to claim 1,
wherein
the control unit is configured to actuate the first and second metering devices to close as a function of a measured value from the weighing system, wherein the respective one of the metering devices is actuated to close when the mass target value of the respective mixing water or solid substance according to the recipe has been fed into the mixer as a function of the measured value from the weighing system.

3. The system according to claim 1,
wherein
the control unit is furthermore configured to, in the event of an overshoot of the actual measured value above the mass target value, advance the closing time of the respective one of the metering devices and, in the event of an undershoot of the actual measured value below the mass target value, delay the closing time of the one of the respective metering devices.

4. The system according to claim 1,
wherein
the control unit is configured such that a dosing tolerance for the respective substance is specified with the recipe and the dosing tolerance is taken into account in the determination of the deviation between the actual measured value and the mass target value after closing the respective one of the metering devices, and determining the change of the closing time of the respective one of the metering devices.

5. The system according to claim 1,
wherein
the control unit is further configured to log the actual measured values of the substances fed into the mixer during the production of a respective batch detected after closing the respective metering device of each of the at least one stockpiling silo in the course of the determination of the deviation, and to provide the actual measured values as an identifiable data set together with a date/time stamp and/or detected environmental or operating data.

6. The system according to claim 1,
wherein
the control unit is configured to log the actual measured values of the substances fed into the mixer during the production of multiple batches detected after closing the respective metering device of each of the at least one stockpiling silo in the course of the determination of the deviation, to cumulate them as a consumption value of the respective substances, to provide them as an identifiable data set, and to trigger a warning and/or an order for replenishment of the respective substance when it is determined that a stock of the respective substance in the at least one stockpiling silo is underrun.

7. The system according to claim 6,
wherein
the control unit is configured to determine and provide, based on the identifiable data set, a current mixing output of the system.

8. The system according to claim 1,
wherein
the control unit has a display with a touch screen for touch inputs, on which components of the system and production-relevant parameters of the components for monitoring sequences of events in a process diagram are visualized and inputs of the recipe can be made.

9. A method for batchwise producing a construction material suspension with a system comprising a water supply tank with a first metering device at an outlet thereof, at least one stockpiling silo for storing a free-flowing or flowable solid substance, the at least one stockpiling silo having a respective second metering device at an outlet thereof, a mixer which is arranged such that it is chargeable with mixing water from the water supply tank and the solid substance from the at least one stockpiling silo by opening the respective first and second metering devices, and a weighing system for continuously measuring a mass of the mixing water and a mass of the solid substance fed into the mixer, the method comprising the steps of:
specifying a recipe with mass target values of substances of a batch of the construction material suspension to be produced,
actuating, based on the mass target values of the recipe, the first and second metering devices to open and close successively to feed mixing water and one or more substance of a batch of the construction material suspension into the mixer according to the recipe, wherein a respective one of the metering devices is actuated to close as soon as the mass target value of the respective mixing water or substance according to the recipe has been fed into the mixer,
after actuating to close the respective one of the metering devices and before actuating to open a next metering device, within a defined time interval determine a deviation between an actual measured value from the weighing system and the target value of a mass previously fed into the mixer, and
determine, from the deviation, a change of a closing time of the one of the respective metering devices and use the change of the closing time during production of a subsequent batch of the recipe when actuating the closing of the respective one of the metering devices.

10. The method according to claim 9,
wherein
the first and second metering devices are actuated to close as a function of a measured value from the weighing system, wherein the respective one of the metering devices is actuated to close when the mass target value of the respective mixing water or substance according to the recipe has been fed into the mixer as a function of the measured value from the weighing system.

11. The method according to claim 9,
wherein
in the event of an overshoot of the actual measured value above the target value, the closing time of the respective metering device is advanced, and in the event of an undershoot of the actual measured value below the mass target value, the closing time of the one of the respective metering devices is delayed.

12. The method according to claim 9,
wherein
a dosing tolerance for the respective substance is specified with the recipe and the dosing tolerance is taken into account in the determination of the deviation between the actual measured value and the mass target value after closing the respective one of the metering devices and determining the change of the closing time of the respective one of the metering devices.

13. The method according to claim 9,
wherein
the actual measured values of the substances fed into the mixer during the production of a respective batch, detected after closing the respective metering device of each of the at least one stockpiling silo in the course of the determination of the deviation, are logged and provided as an identifiable data set together with a date/time stamp and/or detected environmental or operating data.

14. The method according to claim 9,
wherein
the actual measured values of the substances fed into the mixer during the production of multiple batches, detected after closing the respective metering device of each of the at least one stockpiling silo in the course of the determination of the deviation, are logged and cumulated as a consumption value of the respective substances, provided as an identifiable data set, and used to trigger a warning and/or an order for replenishment of the respective substance when it is determined that a stock of the respective substance in the at least one stockpiling silo is underrun.
